(19) United States
(12) Patent Application Publication
(10) Pub. No.: US 2025/0206884 A1
(43) Pub. Date: Jun. 26, 2025

(54) ULTRAVIOLET RADIATION-CURABLE POLYSILOXANE COMPOSITION, AND DAMPING MATERIAL

(71) Applicant: TAICA CORPORATION, Tokyo (JP)

(72) Inventors: Shota Ijichi, Tokyo (JP); Kota Imai, Tokyo (JP)

(73) Assignee: TAICA CORPORATION, Tokyo (JP)

(21) Appl. No.: 18/851,458

(22) PCT Filed: Mar. 10, 2023
(86) PCT No.: PCT/JP2023/009382

§ 371 Date: Sep. 26, 2024

(30) Foreign Application Priority Data
Mar. 31, 2022 (JP) 2022-057773

(51) Int. Cl. C08G 75/045; C08K 5/13; C08K 5/3432

(52) U.S. Cl. CPC C08G 75/045; C08K 5/13; C08K 5/3432; C08G 2350/00

(57) ABSTRACT

Provided is a UV-curable polysiloxane composition which is cured uniformly on the surface and in the inside with a small amount of UV irradiation and can form a silicone gel effective for vibration control and damping in small driving devices. The UV-curable polysiloxane composition of the present invention includes 100 parts by mass of an organopolysiloxane (A) having at least one vinyl group, a mercaptoalkyl group-containing organopolysiloxane (B) in such part(s) by mass that the number of moles of the mercaptoalkyl group is 0.1 to 1.0 mole based on 1 mole of the vinyl group of the organopolysiloxane (A), 0.1 to 5 parts by mass of a photoinitiator (C) based on 100 parts by mass of the organopolysiloxane (A) and 0.5 to 5 parts by mass of a piperidone derivative (D) based on 100 parts by mass of the organopolysiloxane (A).

### DESCRIPTION

### Technical Field

The present invention relates to a UV-curable polysiloxane composition and a damping material comprising a cured product thereof, and more specifically, to a UV-curable polysiloxane composition having excellent uniformity of curing on the surface and in the inside and excellent UV curing properties, and a damping material comprising a cured product thereof.

### Background Art

Silicone gel is a viscoelastic material made by cross-linking organopolysiloxane having an alkenyl group such as a vinyl group bonded to a silicon atom with a cross-linking agent in the presence of an addition reaction catalyst. Having small complex modulus of elasticity and large loss coefficient (tan δ), silicone gel is flexible and is excellent in absorbing shock and vibration, and also is excellent in mechanical strength, heat resistance, cold resistance, and the like. Thus, silicone gel is used in a wide range of fields, for example as an adhesive, a sealant, a potting material, a coating material and a damping material for driving devices and the like that require precise control, such as optical pickup devices. In particular, for vibration control and damping in drive units of optical pickup devices and the like, a UV-curable polysiloxane composition, which can be supplied in an uncured state (liquid state) and cured with UV light to form a silicone gel at the site where vibration control and damping are intended, is used taking advantage of the assembling workability of silicone gel.

A composition with an ene-thiol reaction system, which includes a cross-linking agent composed of an organopolysiloxane containing at least two mercaptoalkyl groups per molecule and a main agent composed of an organopolysiloxane containing at least two alkenyl groups per molecule, is used as the above type of UV-curable polysiloxane composition in order to avoid the inhibition of curing by oxygen.

In recent years, as electrical and electronic devices have become smaller, the drive units used in these devices have also become smaller, and the volume and thickness of silicone gel used as damping material have become smaller and thinner. Therefore, if the silicone gel used is a UV-curable polysiloxane composition cured in such a manner that the surface and the inside are not uniform, the non-uniformly cured state will affect the damping performance, and thus it is important to make the silicone gel uniform in its cured state in order to control the driving device with high accuracy. However, a film-like surface layer in which curing has proceeded more than the interior may be formed near the surface of the silicone gel into which ultraviolet light has entered, and if the volume of the silicone gel is small, the non-uniformly cured state caused by the formation of the surface layer might affect damping performance. As a means of eliminating this impact, Patent Literature 1 discloses that when a UV-curable silicone composition is cured by irradiating it with a specific ultraviolet light, the surface becomes harder than the interior to form a less adhesive silicone gel on the surface, and Patent Literature 1 reports that depending on the ultraviolet irradiation conditions, the surface is not hardened and becomes uniform with the interior. Thus, methods to suppress the formation of silicone gel surface layers due to ultraviolet irradiation conditions have been studied, but in the production process where damping materials are applied, adjustment of irradiation conditions and changes in ultraviolet light sources affect productivity, and thus use of a UV-curable polysiloxane composition with excellent uniformity in curing is desired.

Then the present applicant proposes a UV-curable silicone gel composition prepared by adding a specific hindered amine-based compound to a silicone gel composed of an organopolysiloxane having at least one vinyl group, a mercaptoalkyl group-containing organopolysiloxane and a photoinitiator (Patent Literature 2). The UV-curable silicone gel composition disclosed in Patent Literature 2 has excellent curing uniformity on the surface and in the inside without the need for special UV irradiation conditions as in the curing method of Patent Literature 1.

### CITATION LIST

### Patent Literature

Patent Literature 1: Japanese Patent Laid-Open No. 8-231732

Patent Literature 2: Japanese Patent Laid-Open No. 2020-172581

### SUMMARY OF INVENTION

### Technical Problem

However, the UV-curable silicone gel composition disclosed in Patent Literature 2 requires a larger amount of UV irradiation (integrated light intensity) than conventional ones, specifically an integrated light intensity of 3,000 mJ/cm² or more, to be cured, and large energy consumption was the problem. Therefore, there was room for improvement in facilitating curing even at low integrated light intensity in order to reduce energy consumption. The present invention thus has been made in view of the above circumstances and the first object of the present invention is to provide a UV-curable polysiloxane composition which is cured uniformly on the surface and in the inside with a small amount of UV irradiation and can form a silicone gel effective for vibration control and damping in small driving devices.

The second object of the present invention is to provide a damping material with a uniformly cured structure on the surface and in the inside, and with excellent damping performance.

### Solution to Problem

The UV-curable polysiloxane composition of the present invention comprises 100 parts by mass of an organopolysiloxane (A) having at least one vinyl group, a mercaptoalkyl group-containing organopolysiloxane (B) in such part(s) by mass that the number of moles of the mercaptoalkyl group is 0.1 to 1.0 mole based on 1 mole of the vinyl group of the organopolysiloxane (A), 0.1 to 5 parts by mass of a photoinitiator (C) based on 100 parts by mass of the organopolysiloxane (A) and 0.5 to 5 parts by mass of a piperidone derivative (D) based on 100 parts by mass of the organopolysiloxane (A).

Since the UV-curable polysiloxane composition of the present invention comprises 0.5 to 5 parts by mass of the piperidone derivative (D) based on 100 parts by mass of the organopolysiloxane (A), generation of a film-like surface layer can be prevented on the surface irradiated with ultraviolet light and the surface and the inside can be uniformly cured, and also the composition can be rapidly cured under conditions of a small amount of UV irradiation, and thus a cured product (silicone ge1) can be formed with small integrated light intensity.

In the UV-curable polysiloxane composition of the present invention, the piperidone derivative (D) is preferably a 4-piperidone derivative. By selecting a 4-piperidone derivative as the piperidone derivative (D), a UV-curable polysiloxane composition which can be cured rapidly under conditions of a small amount of UV irradiation to form a silicone gel with small integrated light intensity and which provides an improved effect of uniformly curing the surface and the inside can be obtained.

In the UV-curable polysiloxane composition of the present invention, a functional group bonded to a nitrogen atom in a nitrogen-containing six-membered ring in the 4-piperidone derivative described above is preferably a linear or branched alkyl group. By selecting a 4-piperidone derivative in which a linear or branched alkyl group is bonded to a nitrogen atom in a nitrogen-containing six-membered ring as the piperidone derivative (D), a UV-curable polysiloxane composition which can be cured rapidly under conditions of a small amount of UV irradiation to form a silicone gel with small integrated light intensity and which provides an improved effect of uniformly curing the surface and the inside can be obtained.

In the UV-curable polysiloxane composition of the present invention, the 4-piperidone derivative, which is a piperidone derivative (D), is preferably 1-methyl-4-piperidone. By selecting 1-methyl-4-piperidone as the piperidone derivative (D), a UV-curable polysiloxane composition which can be cured rapidly under conditions of a smaller amount of UV irradiation to form a silicone gel with small integrated light intensity and which provides a superior effect of uniformly curing the surface and the inside can be obtained.

In the UV-curable polysiloxane composition of the present invention, the piperidone derivative (D) is preferably a 2-piperidone derivative. By selecting a 2-piperidone derivative as the piperidone derivative (D), a UV-curable polysiloxane composition which can be cured rapidly under conditions of a small amount of UV irradiation to form a silicone gel with small integrated light intensity and which provides an improved effect of uniformly curing the surface and the inside can be obtained.

In the UV-curable polysiloxane composition of the present invention, a functional group bonded to a nitrogen atom in a nitrogen-containing six-membered ring in the 2-piperidone derivative described above is preferably a linear or branched alkyl group. By selecting a 2-piperidone derivative in which a linear or branched alkyl group is bonded to a nitrogen atom in a nitrogen-containing six-membered ring as the piperidone derivative (D), a UV-curable polysiloxane composition which can be cured rapidly under conditions of a small amount of UV irradiation to form a silicone gel with small integrated light intensity and which provides an improved effect of uniformly curing the surface and the inside can be obtained.

In the UV-curable polysiloxane composition of the present invention, the 2-piperidone derivative, which is a piperidone derivative (D), is preferably 1, 5-dimethyl-2-piperidone. By selecting 1,5-dimethyl-2-piperidone as the piperidone derivative (D), a UV-curable polysiloxane composition which can be cured rapidly under conditions of a smaller amount of UV irradiation to form a silicone gel with small integrated light intensity and which provides a superior effect of uniformly curing the surface and the inside can be obtained.

It is also preferable that the UV-curable polysiloxane composition of the present invention further comprises 0.5 to 5 parts by mass of a hindered phenol compound (E) based on 100 parts by mass of the organopolysiloxane (A). The combination use of the hindered phenol compound (E) with the piperidone derivative (D) can provide a UV-curable polysiloxane composition which can be formed into a silicone gel which is uniformly cured on the surface and in the inside even under conditions of a small amount of UV irradiation.

The damping material of the present invention comprises a cured product of the above UV-curable polysiloxane composition. The cured product of the above UV-curable polysiloxane composition, namely, silicone gel, has a structure in which the surface and the inside are uniformly cured, and thus has uniform damping performance and is excellent in vibration control and damping.

### Advantageous Effects of Invention

According to the present invention, since the UV-curable polysiloxane composition comprises the basic components of an organopolysiloxane (A) having at least one vinyl group, a mercaptoalkyl group-containing organopolysiloxane (B) and a photoinitiator (C), and a new piperidone derivative (D), the composition can be rapidly cured under conditions of a small amount of UV irradiation to form a cured product (silicone ge1) with small integrated light intensity. Since the surface and the inside are uniformly cured, stable damping performance can be achieved in vibration control and damping in driving devices that require precise drive control, even when a small volume of a damping material made of the cured product is used. Furthermore, by using the piperidone derivative (D) and the hindered phenol compound (E) together, the composition can be more rapidly cured under conditions of a small amount of UV irradiation while achieving uniform curability on the surface and in the inside, and thus a cured product (silicone ge1) can be prepared at low energy.

### DESCRIPTION OF EMBODIMENTS

In the following, the UV-curable polysiloxane composition and the damping material comprising a cured product thereof of the present invention will be described in detail.

### 1. UV-Curable Polysiloxane Composition

The UV-curable polysiloxane composition of the present invention comprises an organopolysiloxane (A) having at least one vinyl group, an organopolysiloxane containing a mercaptoalkyl group (B), a photoinitiator (C) and a piperidone derivative (D). In the present description, the organopolysiloxane (A) is also referred to as vinyl group-containing organopolysiloxane (A) and the organopolysiloxane (B) is also referred to as mercaptoalkyl group-containing organopolysiloxane (B).

### (Vinyl Group-Containing Organopolysiloxane (A))

The vinyl group-containing organopolysiloxane (A) constituting the UV-curable polysiloxane composition of the present invention is an organopolysiloxane (A) having at least one vinyl group per molecule, and is the main component of the UV-curable polysiloxane composition of the present invention. The bonding position of the vinyl group in the component (A) is not limited, and the vinyl group may be bonded to the molecular chain terminals or to the side chain, or may be bonded to both. The organic group other than the vinyl group, which is bonded to the silicon atom in the vinyl group-containing organopolysiloxane (A), is substituted by a methyl group or a phenyl group. It is preferable that the vinyl group-containing organopolysiloxane (A) has a substantially straight molecular structure (linear), but may have a branched structure in some part. Specific examples of vinyl group-containing organopolysiloxanes (A) include dimethylsiloxane having the molecular chain terminals blocked with a dimethylvinylsiloxy group, a dimethylsiloxane/diphenylsiloxane copolymer having the molecular chain terminals blocked with a dimethylvinylsiloxy group, a dimethylsiloxane/methylvinylsiloxane/diphenylsiloxane copolymer having the molecular chain terminals blocked with a dimethylvinylsiloxy group, dimethylsiloxane having the one molecular chain terminal blocked with dimethylvinylsiloxy group and having the another molecular chain terminal blocked with a trimethylsiloxy group, dimethylsiloxane having the one molecular chain terminal blocked with dimethylvinylsiloxy group and having the another molecular chain terminal blocked with a trimethylsiloxy group, methylvinylsiloxane/diphenylsiloxane, a dimethylsiloxane/methylvinylsiloxane copolymer having the both molecular chain terminals blocked with a trimethylsiloxy group, and a dimethylsiloxane/methylvinylsiloxane/diphenylsiloxane copolymer having the both molecular chain terminals blocked with a trimethylsiloxy group. These may be used alone or in combination of two or more.

### (Mercaptoalkyl Group-Containing Organopolysiloxane (B))

The mercaptoalkyl group-containing organopolysiloxane (B) constituting the UV-curable polysiloxane composition of the present invention is a cross-linking agent component which allows ene-thiol reaction between the vinyl group of the vinyl group-containing organopolysiloxane (A) and the mercaptoalkyl group of the component (B) to cross-link the vinyl group-containing organopolysiloxane (A), and an example is an organopolysiloxane substituted by a mercaptoalkyl group at both molecular chain terminals or in the side chain. More specifically, a mercaptoalkyl group-containing organopolysiloxane composed of a (CH₃)₃SiO_{1/2} unit, a (CH₃)(HS(CH₂)ₙ)SiO_{2/2} unit (n is an integer of 2 to 20) and a (CH₃)₂SiO_{2/2} unit is preferred. An average of more than 3 HS(CH₂), groups (n is an integer of 2 to 20) are more preferably present per molecule from the viewpoint of achieving practical curability. The mercaptoalkyl group is not particularly limited, and examples thereof include a mercaptoethyl group, a mercaptopropyl group and a mercaptohexyl group.

The amount of the mercaptoalkyl group-containing organopolysiloxane (B) added is such that the number of moles of the mercaptoalkyl group in the mercaptoalkyl group-containing organopolysiloxane (B) is 0.1 to 1.0 mole based on 1 mole of the vinyl group in the vinyl group-containing organopolysiloxane (A) from the viewpoint of the curability of UV-curable polysiloxane composition. An amount of the mercaptoalkyl group-containing organopolysiloxane (B) added of less than 0.1 mole reduces curability of the UV-curable polysiloxane composition. An amount of the mercaptoalkyl group-containing organopolysiloxane (B) added of more than 1.0 mole increases the hardness of the cured product (silicone ge1) of the UV-curable polysiloxane composition after curing due to too many cross-linking sites, and the effect of vibration control and damping which is advantageous for damping materials cannot be achieved.

### (Photoinitiator (C))

The photoinitiator (C) constituting the UV-curable polysiloxane composition of the present invention promotes the cross-linking reaction between the vinyl group in the vinyl group-containing organopolysiloxane (A) and the mercaptoalkyl group in the mercaptoalkyl group-containing organopolysiloxane (B) under ultraviolet irradiation, and a known photoinitiator may be used. Specific examples thereof include 1-hydroxy-cyclohexyl-phenyl-ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, bis-(2,6-dimethoxybenzoyl)-2,4,4-trimethylpentylphosphine oxide; and Omnirad 184, 369, 651, 500, 907, 1173 and TPO H (all made by BASF SE). An acetophenone compound is preferred from the viewpoint of the promotion of the cross-linking reaction. The photoinitiator (C) may be used alone or in combination of two or more. The amount of the photoinitiator (C) added is 0.1 to 5 parts by mass based on 100 parts by mass of the vinyl group-containing organopolysiloxane (A) as an effective amount for starting the UV reaction.

### (Piperidone Derivative (D))

The piperidone derivative (D) constituting the UV-curable polysiloxane composition of the present invention is a component which inhibits the formation of a film-like surface layer on the surface of the cured product (silicone ge1) of the UV-curable polysiloxane composition, and allows the cured product to be formed with small integrated light intensity and cures the surface and the inside uniformly. A 2-piperidone derivative, a 3-piperidone derivative or a 4-piperidone derivative may be used as the piperidone derivative (D), and those which are liquid at room temperature (1 to 30° C.) are preferred from the viewpoint of dispersibility in the UV-curable polysiloxane composition. While a known liquid piperidone derivative (D) may be used, it is preferable to select the piperidone derivative (D) from a 2-piperidone derivative and a 4-piperidone derivative from the viewpoint of the effects of curing under conditions of a small amount of UV irradiation to form a silicone gel with small integrated light intensity and uniformly curing the surface and the inside. A 2-piperidone derivative, a 3-piperidone derivative or a 4-piperidone derivative may be used alone or two or more of them may be selected and used in combination as the piperidone derivative (D).

For the 4-piperidone derivative, the degree of effects of curing the surface and the inside uniformly under conditions of a smaller amount of UV irradiation varies depending on the type of the functional group bonded to the nitrogen atom in the nitrogen-containing six-membered ring. Specific examples of 4-piperidone derivatives include, in addition to 4-piperidone in which the functional group bonded to the nitrogen atom in the nitrogen-containing six-membered ring is a hydrogen atom, a 4-piperidone derivative such as 1-methyl-4-piperidone, 1-ethyl-4-piperidone, 1-propionyl-4-piperidone, 1-isopropyl-4-piperidone and 1,2,2,6,6-pentamethyl-4-piperidone, in which the functional group bonded to the nitrogen atom in the nitrogen-containing six-membered ring is a linear or branched alkyl group such as a methyl group, an ethyl group, a n-propyl group, an iso-propyl group, a n-butyl group, an iso-butyl group, a sec-butyl group, a tert-butyl group, a n-pentyl group, a 1-methylbutyl group, a 2-methylbutyl group, a 3-methylbutyl group, a 1, 1-dimethylpropyl group, a 2,2-dimethylpropyl group, a 1-ethylpropyl group, a n-hexyl group, a 1-methylpentyl group, a 2-methylpentyl group, a 3-methylpentyl group, a 1-ethylbutyl group, a 2-ethylbutyl group, a n-heptyl group, a 1-methylhexyl group or a 1-ethylpentyl group. Examples thereof also include a 4-piperidone derivative such as 1-benzyl-4-piperidone, 1-(2-phenylethyl)-4-piperidone and 1-benzyl-3-carbomethoxy-4-piperidone in which the functional group bonded to the nitrogen atom in the nitrogen-containing six-membered ring is a benzyl group; a 4-piperidone derivative such as 1-(2-furylmethyl)-4-piperidone in which the functional group bonded to the nitrogen atom in the nitrogen-containing six-membered ring is a furylmethyl group; a 4-piperidone derivative such as 1-formyl-4-piperidone in which the functional group bonded to the nitrogen atom in the nitrogen-containing six-membered ring is a formyl group; and a 4-piperidone derivative such as 1-trityl-4-piperidone in which the functional group bonded to the nitrogen atom in the nitrogen-containing six-membered ring is a trityl group. Furthermore, 2,2,6,6-tetramethyl-4-piperidone, 3,5-bis[(4-methylphenyl)methylene]-4-piperidone, 3-methoxycarbonyl-4-piperidone, 3,5-bromo-2,2,6,6-tetramethyl-4-piperidone and the like which have a functional group bonded to the carbon atom in the nitrogen-containing six-membered ring may be used as the 4-piperidone derivative. Of them, a 4-piperidone derivative in which the functional group bonded to the nitrogen atom in the nitrogen-containing six-membered ring is a hydrogen atom, a linear or branched alkyl group, a benzyl group, a furylmethyl group or a trityl group and a 4-piperidone derivative having a functional group bonded to the carbon atom in the nitrogen-containing six-membered ring are preferred, and a 4-piperidone derivative in which the functional group is a linear or branched alkyl group is more preferred, and 1-methyl-4-piperidone is further preferred from the viewpoint of the dispersibility in the vinyl group-containing organopolysiloxane (A) and the mercaptoalkyl group-containing organopolysiloxane (B) and uniform curability at low integrated light intensity. A 4-piperidone derivative may be used alone or two or more of them may be used in combination.

For the 2-piperidone derivative, the degree of effects of curing the surface and the inside uniformly under conditions of a smaller amount of UV irradiation varies depending on the type of the functional group bonded to the nitrogen atom in the nitrogen-containing six-membered ring. Specific examples of 2-piperidone derivatives include, in addition to 2-piperidone in which the functional group bonded to the nitrogen atom in the nitrogen-containing six-membered ring is a hydrogen atom, a 2-piperidone derivative such as N-methyl-2-piperidone, 1-ethyl-2-piperidone, 1-propionyl-2-piperidone, 1-isopropyl-2-piperidone and 1,5-dimethyl-2-piperidone, in which the functional group bonded to the nitrogen atom in the nitrogen-containing six-membered ring is a linear or branched alkyl group such as a methyl group, an ethyl group, a n-propyl group, an iso-propyl group, a n-butyl group, an iso-butyl group, a sec-butyl group, a tert-butyl group, a n-pentyl group, a 1-methylbutyl group, a 2-methylbutyl group, a 3-methylbutyl group, a 1,1-dimethylpropyl group, a 2,2-dimethylpropyl group, a 1-ethylpropyl group, a n-hexyl group, a 1-methylpentyl group, a 2-methylpentyl group, a 3-methylpentyl group, a 1-ethylbutyl group, a 2-ethylbutyl group, a n-heptyl group, a 1-methylhexyl group or 1-ethylpentyl group. Examples thereof also include a 2-piperidone derivative such as 1-benzyl-2-piperidone and 1-(2-phenylethyl)-2-piperidone in which the functional group bonded to the nitrogen atom in the nitrogen-containing six-membered ring is a benzyl group; a 2-piperidone derivative such as N-cyclohexyl-2-piperidone in which the functional group bonded to the nitrogen atom in the nitrogen-containing six-membered ring is a cyclohexyl group; a 2-piperidone derivative such as 1-formyl-2-piperidone and 1-(benzoylformyl)-2-piperidone in which the functional group bonded to the nitrogen atom in the nitrogen-containing six-membered ring is a formyl group; and a 2-piperidone derivative such as 1-trityl-2-piperidone in which the functional group bonded to the nitrogen atom in the nitrogen-containing six-membered ring is a trityl group. Furthermore, 1, 5-dimethyl-2-piperidone, 3-amino-2-piperidone, N-chloro-2-piperidone and the like which have a functional group bonded to the carbon atom in the nitrogen-containing six-membered ring may be used as the 2-piperidone derivative. Of them, a 2-piperidone derivative in which the functional group bonded to the nitrogen atom in the nitrogen-containing six-membered ring is a hydrogen atom, a linear or branched alkyl group, a benzyl group, a cyclohexyl group or a trityl group and a 2-piperidone derivative having a functional group bonded to the carbon atom in the nitrogen-containing six-membered ring are preferred, and a 2-piperidone derivative in which the functional group is a linear or branched alkyl group is more preferred, and 1,5-dimethyl-2-piperidone is further preferred from the viewpoint of dispersibility in the vinyl group-containing organopolysiloxane (A) and the mercaptoalkyl group-containing organopolysiloxane (B) and uniform curability at low integrated light intensity. A 2-piperidone derivative may be used alone or two or more of them may be used in combination.

For the 3-piperidone derivative, the degree of effects of curing the surface and the inside uniformly under conditions of a smaller amount of UV irradiation varies depending on the type of the functional group bonded to the nitrogen atom in the nitrogen-containing six-membered ring. Specific examples of 3-piperidone derivatives include, in addition to 3-piperidone in which the functional group bonded to the nitrogen atom in the nitrogen-containing six-membered ring is a hydrogen atom, a 3-piperidone derivative such as 1-methyl-3-piperidone, 1-ethyl-3-piperidone, 1-propionyl-3-piperidone and 1-isopropyl-3-piperidone in which the functional group bonded to the nitrogen atom in the nitrogen-containing six-membered ring is a linear or branched alkyl group such as a methyl group, an ethyl group, a n-propyl group, an iso-propyl group, a n-butyl group, an iso-butyl group, a sec-butyl group, a tert-butyl group, a n-pentyl group, a 1-methylbutyl group, a 2-methylbutyl group, a 3-methylbutyl group, a 1,1-dimethylpropyl group, a 2, 2-dimethylpropyl group, a 1-ethylpropyl group, a n-hexyl group, a 1-methylpentyl group, a 2-methylpentyl group, a 3-methylpentyl group, a 1-ethylbutyl group, a 2-ethylbutyl group, a n-heptyl group, a 1-methylhexyl group or a 1-ethylpentyl group. Examples thereof also include a 3-piperidone derivative such as 1-benzyl-3-piperidone and 1-(2-phenylethyl)-3-piperidone in which the functional group bonded to the nitrogen atom in the nitrogen-containing six-membered ring is a benzyl group; a 3-piperidone derivative such as 1-(2-furylmethyl)-3-piperidone in which the functional group bonded to the nitrogen atom in the nitrogen-containing six-membered ring is a furylmethyl group; a 3-piperidone derivative such as 1-formyl-3-piperidone in which the functional group bonded to the nitrogen atom in the nitrogen-containing six-membered ring is a formyl group; and a 3-piperidone derivative such as 1-trityl-3-piperidone in which the functional group bonded to the nitrogen atom in the nitrogen-containing six-membered ring is a trityl group. Furthermore, 1,5-dimethyl-3-piperidone, N-chloro-3-piperidone and the like which have a functional group bonded to the carbon atom in the nitrogen-containing six-membered ring may be used as the 3-piperidone derivative. Of them, a 3-piperidone derivative in which the functional group bonded to the nitrogen atom in the nitrogen-containing six-membered ring is a hydrogen atom, a linear or branched alkyl group, a benzyl group, a furylmethyl group, a formyl group or a trityl group and a 3-piperidone derivative having a functional group bonded to the carbon atom in the nitrogen-containing six-membered ring are preferred from the viewpoint of dispersibility in the vinyl group-containing organopolysiloxane (A) and the mercaptoalkyl group-containing organopolysiloxane (B) and uniform curability at low integrated light intensity. A 3-piperidone derivative may be used alone or two or more of them may be used in combination.

It is important that the amount of the piperidone derivative (D) added is more than 0.1 part by mass and less than 10 parts by mass based on 100 parts by mass of the vinyl group-containing organopolysiloxane (A), and the amount of the piperidone derivative (D) added is preferably 0.5 to 5 parts by mass, more preferably 1 to 3 parts by weight, and particularly preferably 1.5 to 2.5 parts by mass. The piperidone derivative (D) is added in the above amount because when the amount of the piperidone derivative (D) is 0.1 part by mass or less, the effect of curing the UV-curable polysiloxane composition uniformly is insufficient, and when the amount is 10 parts by mass or more, bleed out from the cured product of the UV-curable polysiloxane composition becomes more pronounced.

### (Hindered Phenol Compound (E))

It is preferable that the UV-curable polysiloxane composition of the present invention further comprises a hindered phenol compound (E). The hindered phenol compound (E) is a component which works together with the piperidone derivative (D) to cause a cross-linking reaction between the vinyl group-containing organopolysiloxane (A) and the mercaptoalkyl group-containing organopolysiloxane (B) under conditions of further low integrated light intensity to improve the curability of the UV-curable polysiloxane composition. Examples of hindered phenol compounds (E) include benzenepropanoic acid, 3,5-bis (1,1-dimethyl-ethyl)-4-hydroxy-C7-C9 branched alkyl ester, pentaerythritol tetrakis[3-(3,5-di-tert-butyl-4-hydroxyphenyl)propionate], thiodiethylenebis[3-(3,5-di-tert-butyl-4-hydroxyphenyl)propionate], octadecyl-3-(3,5-di-tert-butyl-4-hydroxyphenyl)propionate, 2,4-dimethyl-6-(1-methylpentadecyl)phenol, diethyl[{3,5-bis(1,1-di-tert-butyl-4-hydroxyphenyl)methyl}phosphonate, 3,3′,3″,5,5′,5″-hexane-tert-butyl-4-a,a′,a″-(mesitylene-2,4,6-tolyl)tri-p-cresol, 4,6-bis(octylthiomethyl)-o-cresol, ethylenebis(oxyethylene)bis[3-(5-tert-butyl-4-hydroxy-m-tolyl)propionate] and hexamethylenebis[3-(3,5-di-tert-butyl-4-hydroxyphenyl)propionate]. Of them, benzenepropanoic acid, 3,5-bis(1,1-dimethyl-ethyl)-4-hydroxy-C7-C9 branched alkyl ester (for example, tradename Irganox 1135 made by BASF SE) is particularly preferred. One hindered phenol compound (E) may be used or two or more of them may be used in combination.

The content of the component (E) is 0.5 to 5 parts by mass and preferably 1 to 2.5 parts by mass based on 100 parts by mass of the vinyl group-containing organopolysiloxane (A). The component (E) is added in the above amount because when the amount of the component (E) is less than 0.5 part by mass, easiness of curing is insufficient, and when the amount is more than 5 parts by mass, bleed out from the cured product of the UV-curable polysiloxane composition becomes more pronounced.

### (Filler)

The UV-curable polysiloxane composition of the present invention may further comprise a filler in order to achieve viscoelastic properties of the cured product and provide additional functionality. The filler is not particularly limited as long as the filler is powder, has the effect of adjusting viscoelastic properties of the cured product, can provide functionality and does not inhibit the thiol-ene reaction. For example, fumed silica such as AEROSIL (R) made by NIPPON AEROSIL CO., LTD., REOLOSIL (R) made by Tokuyama Corporation and WACKER HDK (R) made by Wacker Asahikasei Silicone Co., Ltd., silica such as TOKUSIL (R) made by Tokuyama Corporation, a silicone resin, metal oxide such as alumina, and a fibrous compound such as cellulose nanofiber may be selected and used appropriately according to the purpose.

### (Other Components)

The UV-curable polysiloxane composition of the present invention may contain other components as needed, to the extent that the effects of the present invention are not impaired. Examples of other components include a thixotropic agent, a heat resistance imparting agent, a flame retardant, a pigment, a dye, an agent for imparting tackiness and adhesiveness and a polymerization inhibitor, and also an additive for improving weatherability, such as an antioxidant, an ultraviolet absorber and light stabilizer. Known ones may be used.

One or more silicone resin adhesion improvers selected from for example MQ resin, MDQ resin, MT resin, MDT resin, MDTQ resin, DQ resin, DTQ resin and TQ resin (which do not contain an aliphatic unsaturated group or a mercapto group) are preferred as the agent for imparting tackiness and adhesiveness. One or more silicone resin adhesion improvers selected from MQ resin, MDQ resin, MDT resin and MDTQ resin are more preferred from the viewpoint of flowability and dispersibility in the UV-curable polysiloxane composition, and MQ resin is further preferred from the viewpoint of the effect of imparting tackiness and the easiness in structure control. Furthermore, a silane coupling agent may be added in order to improve adhesiveness to the object to be bonded. Examples of silane coupling agents include triethoxysilane, 3-mercaptopropyltrimethoxysilane, 3-glycidoxypropyltrimethoxysilane, 3-glycidoxypropyltriethoxysilane, 1,3-bis(3-methacryloxypropyl)tetramethyldisiloxane, trimethoxysilylpropyl diallyl isocyanurate, bis(trimethoxysilylpropyl)allyl isocyanurate, tris(trimethoxysilylpropyl)isocyanurate, triethoxysilylpropyl diallyl isocyanurate, bis(triethoxysilylpropyl)allyl isocyanurate and tris(triethoxysilylpropyl)isocyanurate. A disiloxane compound having a functional group such as (meth)acryloxy group, an alkoxy group (e.g., methoxy, ethoxy, propoxy) and/or an amino group such as 1,3-bis(3-methacryloxypropyl)tetramethyldisiloxane may be used as another example of the silane coupling agent. It is preferable that the disiloxane compound includes an aliphatic unsaturated group out of the above from the viewpoint of the improvement in adhesion and bonding properties. 3-methacryloxypropyltriethoxysilane, 3-methacryloxypropyltrimethoxysilane and 1,3-bis(3-methacryloxypropyl)tetramethyldisiloxane are more preferred. One or two or more agents for imparting tackiness and adhesiveness may be used.

A material which can impart the function of improving weatherability by preventing oxidation of the cured product of the composition of the present invention may be used as an antioxidant. While the hindered phenol compound (E) functions as an antioxidant, other examples include a hindered amine antioxidant. A known hindered amine antioxidant may be selected, and examples thereof include a polycondensate of N,N′,N″,N′″-tetrakis-(4,6-bis(butyl-(N-methyl-2,2,6,6-tetramethylpiperidin-4-yl)amino)-triazin-2-yl)-4,7-diazadecane-1,10-diamine, dibutylamine/1,3,5-triazine/N,N′-bis(2,2,6,6-tetramethyl-4-piperidyl-1,6-hexamethylenediamine/N-(2,2,6,6-tetramethyl-4-piperidyl)butylamine, poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], a polymer of dimethyl succinate and 4-hydroxy-2,2,6,6-tetramethyl-1-piperidineethanol, [a reaction product of decanedioic acid bis(2,2,6,6-tetramethyl-1(octyloxy)-4-piperidyl)ester, 1,1-dimethylethylhydroperoxide and octane (70%)]-polypropylene (30%), bis(1,2,2,6,6-pentamethyl-4-piperidyl)[[3,5-bis(1,1-dimethylethyl)-4-hydroxyphenyl]methyl]butylmalonate, methyl 1,2,2,6,6-pentamethyl-4-piperidylsebacate, bis(2,2,6,6-tetramethyl-4-piperidyl)sebacate, bis(1,2,2,6,6-pentamethyl-4-piperidyl)sebacate, 1-[2-[3-(3,5-di-tert-butyl-4-hydroxyphenyl)propionyloxy]ethyl]-4-[3-(3,5-di-tert-butyl-4-hydroxyphenyl)propionyloxy]-2,2,6,6-tetramethylpiperidine, 4-benzoyloxy-2,2,6,6-tetramethylpiperidine and 8-acetyl-3-dodecyl-7,7,9,9-tetramethyl-1,3,8-triazaspiro[4.5]decane-2,4-dione.

A material which can impart the function of preventing photo-oxidative degradation of the composition of the present invention or a cured product thereof may be used as a light stabilizer. While the piperidone derivative (D) functions as the light stabilizer, other examples include a benzotriazole, a hindered amine or a benzoate compound. Of them, a hindered amine light stabilizer is preferred as the light stabilizer. In particular, it is preferable to use a tertiary amine-containing hindered amine light stabilizer in order to improve storage stability of the composition. Examples of tertiary amine-containing hindered amine light stabilizers include Tinuvin 622LD, Tinuvin 144, CHIMASSORC 119FL (all made by BASF SE); MARK LA-57, LA-62, LA-67, LA-63 (all made by Asahi Denka Co., Ltd.); and Sanol LS-765, LS-292, LS-2626, LS-1114, LS-744 (all made by Sankyo Co., Ltd.). Examples of ultraviolet absorbers which function as a light resistant stabilizer include an ultraviolet absorber such as a benzotriazole, a triazine, a benzophenone or a benzoate compound. A known ultraviolet absorber may be selected, and examples thereof include a benzotriazole ultraviolet absorber such as 2,4-di-tert-butyl-6-(5-chlorobenzotriazol-2-yl)phenol, 2-(2H-benzotriazol-2-yl)-4,6-di-tert-pentylphenol, 2-(2H-benzotriazol-2-yl)-4-(1,1,3,3-tetramethylbutyl)phenol, a reaction product of methyl 3-(3-(2H-benzotriazol-2-yl)-5-tert-butyl-4-hydroxyphenyl)propionate/polyethylene glycol 300 and 2-(2H-benzotriazol-2-yl)-6-(linear and side chain dodecyl)-4-methylphenol, a triazine ultraviolet absorber such as 2-(4,6-diphenyl-1,3,5-triazin-2-yl)-5-[(hexyl)oxy]-phenol, a benzophenone ultraviolet absorber such as octabenzone, and a benzoate ultraviolet absorber such as 2,4-di-tert-butylphenyl-3,5-di-tert-butyl-4-hydroxybenzoate. One or two or more of the above light stabilizer and ultraviolet absorbers may be used.

### (Method for Producing UV-Curable Polysiloxane Composition)

The UV-curable polysiloxane composition of the present invention is produced by mixing the above (A) to (D) components or (A) to (E) components, and a filler and other various components added as needed at a pre-determined mixing ratio. The order of addition of the components (A) to (C), the components (A) to (D) or the like is not limited. The method of mixing is not particularly limited, and for example, a single screw extruder, a twin-screw extruder, a kneader, a Banbury mixer or a roll mill may be used.

### (Cured Product of UV-Curable Polysiloxane Composition)

The UV-curable polysiloxane composition of the present invention is cured to form a cured product (silicone ge1) by irradiation with ultraviolet light. The UV-curable polysiloxane composition of the present invention can provide a cured product (silicone ge1) which is cured rapidly and uniformly on the surface and in the inside with a small amount of UV irradiation. Specifically, while the UV-curable polysiloxane composition disclosed in Patent Literature 2 above (Japanese Patent Laid-Open No. 2020-172581) requires an integrated light intensity of 3,000 mJ/cm² or more, the UV-curable polysiloxane composition of the present invention can form a cured product (silicone ge1) uniformly cured on the surface and in the inside at an integrated light intensity of 2,000 mJ/cm² or less, and thus has excellent curability at low energy. More specifically, the integrated light intensity of ultraviolet light may be an intensity that is sufficient for the UV-curable polysiloxane composition to be cured, and an integrated light intensity ranging from 500 to 2,000 mJ/cm² may be selected. The integrated light intensity is for example set to preferably 500 to 2,000 mJ/cm², more preferably 500 to 1, 500 mJ/cm² and further preferably 500 to 1,000 mJ/cm². A cured product uniformly cured on the surface and in the inside can be obtained at such low integrated light intensity. The light source of the ultraviolet light and the range of the wavelength of the ultraviolet light for irradiation are not particularly limited, and a known source such as a low pressure mercury lamp, medium pressure mercury lamp, high pressure mercury lamp, ultra-high pressure mercury lamp, a black light lamp, a microwave excitation mercury lamp, a metal halide lamp, a sodium lamp, a halogen lamp, a xenon lamp, an LED, a fluorescent lamp, sun light and an electron beam irradiation device may be used.

### 2. Damping Material

The damping material of the present invention is made of a cured product (silicone ge1) of the above UV-curable polysiloxane composition, and since the material has a structure in which the surface and the inside are uniformly cured, the material has excellent damping properties, and has excellent damping performance even used in a small volume. The damping material may be formed, for example, by supplying the UV-curable polysiloxane composition to the area in which vibration control and damping are intended, and curing the composition by irradiating it with UV light simultaneously with or after supplying it. The damping properties of the damping material and the like may be adjusted by changing the mixing ratio of each component of the above UV-curable polysiloxane composition within the above range.

### EXAMPLES

The present invention will be described in detail with reference to Examples and Comparative Examples, but the present invention is not limited to these Examples.

The compounds for the respective components used in Examples and Comparative Examples are as follows.

### <Vinyl Group-Containing Organopolysiloxane (A)>

Dimethylsiloxane having the molecular chain terminals blocked with dimethylvinylsiloxy groups (DMS-V33 made by Gelest)

### <Mercaptoalkyl Group-Containing Organopolysiloxane (B)>

Copolymer of dimethylsiloxane/mercaptopropyl methylsiloxane having the molecular chain terminal blocked with trimethylsiloxane (SMS-042 made by Gelest)

### <Photoinitiator (C)>

2-hydroxy-2-methyl-1-phenyl-propan-1-one (Omnirad 1173 made by BASF SE)

### <Piperidone Derivative (D)>

(d1) 1-methyl-4-piperidone (made by Tokyo Chemical Industry, Co., Ltd.)
(d2) 1-isopropyl-4-piperidone (made by Tokyo Chemical Industry, Co., Ltd.)
(d3) 1,5-dimethyl-2-piperidone (made by Tokyo Chemical Industry, Co., Ltd.)

### <Hindered Phenol Compound (E)>

(e1) benzenepropanoic acid, 3,5-bis (1,1-dimethyl-ethyl)-4-hydroxy-C7-C9 branched alkyl ester (Irganox 1135 made by BASF)

The methods of the evaluation of the UV-curable polysiloxane compositions in the following Examples and Comparative Examples are as described in the following (1) and (2).

### (1) Curability at Low Energy

Each of the UV-curable polysiloxane compositions was injected into a glass container (inner diameter 45 mm) to a height of 2 mm, and then the minimum integrated light intensity required to cure to the inside was measured by irradiating with ultraviolet light using a high-pressure mercury lamp (Model UVL-1500M2-N1 made by USHIO INC.). Those which required an integrated light intensity of 1,000 mJ/cm² or less was rated as “Excellent” (Excellent), those which required an integrated light intensity of more than 1,000 mJ/cm² and 2,000 mJ/cm² or less was rated as “Good” (Good), and those which required an integrated light intensity of more than 2,000 mJ/cm² was rated as “Failure” (Failure). To confirm the condition of curing to the inside, complex modulus of elasticity Gr* (the standard value when cured to the inside) of the cured product, which was cured to the inside by irradiating an uncured sample with UV light at an integrated light intensity of 6,000 mJ/cm² by the above high-pressure mercury lamp, was compared with complex modulus of elasticity G* of the cured product obtained by irradiating an uncured sample with UV light at an integrated light intensity in the above test. When complex modulus G* was 90% or more of complex modulus Gr*, the composition was rated as being cured to the inside. Complex modulus of elasticity Gr* and G* were measured by a dynamic viscoelastometer (ARES-G2 made by TA Instruments) according to JIS K7244-10 using a disc-shaped sample which was retainable after irradiation with ultraviolet light as a measurement sample, in the torsional shear mode (25° C., frequency 10 Hz). Those which were liquid after UV irradiation or flowed and could not be retained were judged to be in an uncured state, without measurement.

### (2) Curing Uniformity

Each of the UV-curable polysiloxane compositions was injected into a glass container (inner diameter 45 mm) to a height of 2 mm, and then a 2-mm thick cured product was prepared by irradiating the composition with ultraviolet light using a high-pressure mercury lamp (Model UVL-1500M2-N1 made by USHIO INC.). Those which wrinkled on the surface and on which cured coating was formed when the surface of the cured product was pressed by a spatula (3dia microspatel made by Shimizu Akira Inc.) at an integrated light intensity of 3,000 mJ/cm² were rated as “Failure” (Failure), those without cured coating or change on the surface (no wrinkles) at an integrated light intensity of 3,000 mJ/cm² were rated as “Good” (Good), and those without cured coating or change on the surface (no wrinkles) at an integrated light intensity of 9,000 mJ/cm² were rated as “Excellent” (Excellent).

### Example 1

100 parts by mass of vinyl group-containing organopolysiloxane (A), 6.5 parts by mass of mercaptopropyl group-containing organopolysiloxane (B), 1 part by mass of photoinitiator (C) and 0.5 part by mass of (d1): 1-methyl-4-piperidone, which was piperidone derivative (D), were placed in a plastic container with a lid, and the mixture was preliminary mixed, and subjected to main mixing using a rotation/revolution mixer (product name: Awatori Rentaro (R) ARE-250 made by Thinky Corporation) at 2,000 rpm for 2 minutes. The mixture was defoamed at 2, 200 rpm for 1 minute to give a UV-curable polysiloxane composition of Example 1. In the UV-curable polysiloxane composition of Example 1, the amount of the mercaptoalkyl group-containing organopolysiloxane (B) mixed is such part(s) by mass that the number of moles of the mercaptoalkyl group of the mercaptoalkyl group-containing organopolysiloxane (B) is 0.90 mole based on 1 mole of the vinyl group of the vinyl group-containing organopolysiloxane (A). The resulting UV-curable polysiloxane composition was cured by irradiating with ultraviolet light, and the above (1) curability at low energy and (2) curing uniformity were evaluated.

### Examples 2 to 4

The UV-curable polysiloxane compositions of Examples 2 to 4 were prepared in the same manner as in Example 1 except for changing the amount mixed of (d1): 1-methyl-4-piperidone, which was the piperidone derivative (D), as shown in Table 1. The resulting UV-curable polysiloxane compositions were cured by irradiating with ultraviolet light, and the above (1) curability at low energy and (2) curing uniformity were evaluated.

The results of evaluation in Examples 1 to 4 are shown in Table 1.

TABLE 1

| | | | Example | Example | Example | Example |
|---|---|---|---|---|---|---|
| | | | 1 | 2 | 3 | 4 |
| Constitution | (A) Vinyl group- | Amount mixed | 100 | 100 | 100 | 100 |
| | containing | (part(s) by | | | | |
| | organopolysiloxane | mass) | | | | |
| | (B) Mercaptoalkyl | Amount mixed | 6.5 | 6.5 | 6.5 | 6.5 |
| | group-containing | (part(s) by | | | | |
| | organopolysiloxane | mass) | | | | |
| | (C) Photoinitiator | Amount mixed | 1 | 1 | 1 | 1 |
| | | (part(s) by | | | | |
| | | mass) | | | | |
| | (D) Piperidone | Component | d1 | d1 | d1 | d1 |
| | derivative | Amount mixed | 0.5 | 1 | 2 | 5 |
| | | (part(s) by | | | | |
| | | mass) | | | | |
| | (E) Hindered phenol | Amount mixed | 0 | 0 | 0 | 0 |
| | compound | (part(s) by | | | | |
| | | mass) | | | | |
| Evaluation | Curability at low energy | Rating | Excellent | Excellent | Excellent | Good |
| | Curing uniformity | Rating | Good | Good | Excellent | Excellent |
| | (presence or absence of | | | | | |
| | cured coating) | | | | | |

### Example 5

The UV-curable polysiloxane composition of Example 5 was prepared in the same manner as in Example 1 except for changing (d1): 1-methyl-4-piperidone to (d2): 1-isopropyl-4-piperidone as the piperidone derivative (D). The resulting UV-curable polysiloxane composition was cured by irradiating with ultraviolet light, and the above (1) curability at low energy and (2) curing uniformity were evaluated.

### Examples 6 to 8

The UV-curable polysiloxane compositions of Examples 6 to 8 were prepared in the same manner as in Example 5 except for changing the amount mixed of (d2): 1-isopropyl-4-piperidone, which was the piperidone derivative (D), as shown in Table 2. The resulting UV-curable polysiloxane compositions were cured by irradiating with ultraviolet light, and the above (1) curability at low energy and (2) curing uniformity were evaluated.

The results of evaluation in Examples 5 to 8 are shown in Table 2.

TABLE 2

| | | | Example | Example | Example | Example |
|---|---|---|---|---|---|---|
| | | | 5 | 6 | 7 | 8 |
| Constitution | (A) Vinyl group- | Amount mixed | 100 | 100 | 100 | 100 |
| | containing | (part(s) by | | | | |
| | organopolysiloxane | mass) | | | | |
| | (B) Mercaptoalkyl group- | Amount mixed | 6.5 | 6.5 | 6.5 | 6.5 |
| | containing | (part(s) by | | | | |
| | organopolysiloxane | mass) | | | | |
| | (C) Photoinitiator | Amount mixed | 1 | 1 | 1 | 1 |
| | | (part(s) by | | | | |
| | | mass) | | | | |
| | (D) Piperidone | Component | d2 | d2 | d2 | d2 |
| | derivative | Amount mixed | 0.5 | 1 | 2 | 5 |
| | | (part(s) by | | | | |
| | | mass) | | | | |
| | (E) Hindered phenol | Amount mixed | 0 | 0 | 0 | 0 |
| | compound | (part(s) by | | | | |
| | | mass) | | | | |
| Evaluation | Curability at low energy | Rating | Excellent | Good | Good | Good |
| | Curing uniformity | Rating | Good | Good | Excellent | Excellent |
| | (presence or absence of | | | | | |
| | cured coating) | | | | | |

### Example 9

The UV-curable polysiloxane composition of

Example 9 was prepared in the same manner as in Example 1 except for changing (d1): 1-methyl-4-piperidone to (d3): 1,5-dimethyl-2-piperidone as the piperidone derivative (D). The resulting UV-curable polysiloxane composition was cured by irradiating with ultraviolet light, and the above (1) curability at low energy and (2) curing uniformity were evaluated.

### Examples 10 to 12

The UV-curable polysiloxane compositions of Examples 10 to 12 were prepared in the same manner as in Example 9 except for changing the amount mixed of (d3): 1,5-dimethyl-2-piperidone, which was the piperidone derivative (D), as shown in Table 3. The resulting UV-curable polysiloxane compositions were cured by irradiating with ultraviolet light, and the above (1) curability at low energy and (2) curing uniformity were evaluated.

The results of evaluation in Examples 9 to 12 are shown in Table 3.

TABLE 3

| | | | Example | Example | Example | Example |
|---|---|---|---|---|---|---|
| | | | 9 | 10 | 11 | 12 |
| Constitution | (A) Vinyl group- | Amount mixed | 100 | 100 | 100 | 100 |
| | containing | (part(s) by | | | | |
| | organopolysiloxane | mass) | | | | |
| | (B) Mercaptoalkyl | Amount mixed | 6.5 | 6.5 | 6.5 | 6.5 |
| | group-containing | (part(s) by | | | | |
| | organopolysiloxane | mass) | | | | |
| | (C) Photoinitiator | Amount mixed | 1 | 1 | 1 | 1 |
| | | (part(s) by | | | | |
| | | mass) | | | | |
| | (D) Piperidone | Component | d3 | d3 | d3 | d3 |
| | derivative | Amount mixed | 0.5 | 1 | 2 | 5 |
| | | (part(s) by | | | | |
| | | mass) | | | | |
| | (E) Hindered phenol | Amount mixed | 0 | 0 | 0 | 0 |
| | compound | (part(s) by | | | | |
| | | mass) | | | | |
| Evaluation | Curability at low energy | Rating | Excellent | Excellent | Excellent | Good |
| | Curing uniformity | Rating | Good | Good | Excellent | Excellent |
| | (presence or absence of | | | | | |
| | cured coating) | | | | | |

### Example 13

The UV-curable polysiloxane composition of Example 13 was prepared in the same manner as in Example 2 except for further mixing 0.5 part by mass of (e1) benzenepropanoic acid, 3,5-bis(1,1-dimethyl-ethyl)-4-hydroxy-C7-C9 branched alkyl ester as the hindered phenol compound (E). The resulting UV-curable polysiloxane composition was cured by irradiating with ultraviolet light, and the above (1) curability at low energy and (2) curing uniformity were evaluated.

### Examples 14 and 15

The UV-curable polysiloxane compositions of Examples 14 and 15 were prepared in the same manner as in Example 13 except for changing the amount mixed of (e1) benzenepropanoic acid, 3,5-bis(1,1-dimethyl-ethyl)-4-hydroxy-C7-C9 branched alkyl ester, which was the hindered phenol compound (E), as shown in Table 4. The resulting UV-curable polysiloxane compositions were cured by irradiating with ultraviolet light, and the above (1) curability at low energy and (2) curing uniformity were evaluated.

### Example 16

The UV-curable polysiloxane composition of Example 16 was prepared in the same manner as in Example 6 except for further mixing 0.5 part by mass of (e1) benzenepropanoic acid, 3,5-bis(1,1-dimethyl-ethyl)-4-hydroxy-C7-C9 branched alkyl ester as the hindered phenol compound (E). The resulting UV-curable polysiloxane composition was cured by irradiating with ultraviolet light, and the above (1) curability at low energy and (2) curing uniformity were evaluated.

### Example 17

The UV-curable polysiloxane composition of Example 17 was prepared in the same manner as in Example 10 except for further mixing 1.0 part by mass of (e1) benzenepropanoic acid, 3,5-bis(1,1-dimethyl-ethyl)-4-hydroxy-C7-C9 branched alkyl ester as the hindered phenol compound (E). The resulting UV-curable polysiloxane composition was cured by irradiating with ultraviolet light, and the above (1) curability at low energy and (2) curing uniformity were evaluated.

The results of evaluation in Examples 13 to 17 are shown in Table 4.

TABLE 4

| | | | Example | Example | Example | Example | Example |
|---|---|---|---|---|---|---|---|
| | | | 13 | 14 | 15 | 16 | 17 |
| Constitution | (A) Vinyl group- | Amount | 100 | 100 | 100 | 100 | 100 |
| | containing | mixed (part(s) | | | | | |
| | organopolysiloxane | by mass) | | | | | |
| | (B) Mercaptoalkyl | Amount | 6.5 | 6.5 | 6.5 | 6.5 | 6.5 |
| | group-containing | mixed (part(s) | | | | | |
| | organopolysiloxane | by mass) | | | | | |
| | (C) Photoinitiator | Amount | 1 | 1 | 1 | 1 | 1 |
| | | mixed (part(s) | | | | | |
| | | by mass) | | | | | |
| | (D) Piperidone | Component | d1 | d1 | d1 | d2 | d3 |
| | derivative | Amount | 1 | 1 | 1 | 1 | 1 |
| | | mixed (part(s) | | | | | |
| | | by mass) | | | | | |
| | (E) Hindered phenol | Amount | 0.5 | 1 | 5 | 1 | 1 |
| | compound | mixed (part(s) | | | | | |
| | | by mass) | | | | | |
| Evaluation | Curability at low | Rating | Excellent | Excellent | Good | Good | Excellent |
| | energy | | | | | | |
| | Curing uniformity | Rating | Excellent | Excellent | Excellent | Excellent | Excellent |
| | (presence or absence | | | | | | |
| | of cured coating) | | | | | | |

### Comparative Example 1

The UV-curable polysiloxane composition of Comparative Example 1 was prepared in the same manner as in Example 1 except for not mixing the piperidone derivative (D). The resulting UV-curable polysiloxane composition was cured by irradiating with ultraviolet light, and the above (1) curability at low energy and (2) curing uniformity were evaluated.

### Comparative Examples 2 and 3

The UV-curable polysiloxane compositions of Comparative Examples 2 and 3 were prepared in the same manner as in Example 1 except for changing the amount mixed of (d1): 1-methyl-4-piperidone, which was the piperidone derivative (D), as shown in Table 5. The resulting UV-curable polysiloxane compositions were cured by irradiating with ultraviolet light, and the above (1) curability at low energy and (2) curing uniformity were evaluated.

### Comparative Examples 4 and 5

The UV-curable polysiloxane compositions of Comparative Examples 4 and 5 were prepared in the same manner as in Example 5 except for changing the amount mixed of (d2): 1-isopropyl-4-piperidone, which was the piperidone derivative (D), as shown in Table 5. The resulting UV-curable polysiloxane compositions were cured by irradiating with ultraviolet light, and the above (1) curability at low energy and (2) curing uniformity were evaluated.

The results of evaluation in Comparative Examples 1 to 5 are shown in Table 5.

TABLE 5

| | | | Comparative | Comparative | Comparative | Comparative | Comparative |
|---|---|---|---|---|---|---|---|
| | | | Example 1 | Example 2 | Example 3 | Example 4 | Example 5 |
| Constitution | (A) Vinyl group- | Amount | 100 | 100 | 100 | 100 | 100 |
| | containing | mixed | | | | | |
| | organopolysiloxane | (part(s) by | | | | | |
| | | mass) | | | | | |
| | (B) Mercaptoalkyl | Amount | 6.5 | 6.5 | 6.5 | 6.5 | 6.5 |
| | group-containing | mixed | | | | | |
| | organopolysiloxane | (part(s) by | | | | | |
| | | mass) | | | | | |
| | (C) Photoinitiator | Amount | 1 | 1 | 1 | 1 | 1 |
| | | mixed | | | | | |
| | | (part(s) by | | | | | |
| | | mass) | | | | | |
| | (D) Piperidone | Component | — | d1 | d1 | d2 | d2 |
| | derivative | Amount | 0 | 0.1 | 10 | 0.1 | 10 |
| | | mixed | | | | | |
| | | (part(s) by | | | | | |
| | | mass) | | | | | |
| | (E) Hindered | Amount | 0 | 0 | 0 | 0 | 0 |
| | phenol compound | mixed | | | | | |
| | | (part(s) by | | | | | |
| | | mass) | | | | | |
| Evaluation | Curability at low | Rating | Excellent | Excellent | Failure | Excellent | Failure |
| | energy | | | | | | |
| | Curing uniformity | Rating | Failure | Failure | Failure | Failure | Failure |
| | (presence or | | | | | | |
| | absence of cured | | | | | | |
| | coating) | | | | | | |

### Comparative Examples 6 and 7

The UV-curable polysiloxane compositions of Comparative Examples 6 and 7 were prepared in the same manner as in Example 9 except for changing the amount mixed of (d3): 1,5-dimethyl-2-piperidone, which was the piperidone derivative (D), as shown in Table 6. The resulting UV-curable polysiloxane compositions were cured by irradiating with ultraviolet light, and the above (1) curability at low energy and (2) curing uniformity were evaluated.

### Comparative Example 8

The UV-curable polysiloxane composition of Comparative Example 8 was prepared in the same manner as in Example 3 except for mixing 2.0 parts by mass of (f1) 1-phenylpiperidine, which was used in Patent Literature 2 described above, as the hindered amine compound (F) instead of the piperidone derivative (D). The resulting UV-curable polysiloxane composition was cured by irradiating with ultraviolet light, and the above (1) curability at low energy and (2) curing uniformity were evaluated.

### Comparative Example 9

The UV-curable polysiloxane composition of Comparative Example 9 was prepared in the same manner as in Example 3 except for mixing 2.0 parts by mass of (f2) ethyl 1-methyl pipecolinate, which was used in Patent Literature 2 described above, as the hindered amine compound (F) instead of the piperidone derivative (D). The resulting UV-curable polysiloxane composition was cured by irradiating with ultraviolet light, and the above (1) curability at low energy and (2) curing uniformity were evaluated.

The results of evaluation in Comparative Examples 6 to 9 are shown in Table 6.

TABLE 6

| | | | Comparative | Comparative | Comparative | Comparative |
|---|---|---|---|---|---|---|
| | | | Example 6 | Example 7 | Example 8 | Example 9 |
| Constitution | (A) Vinyl group- | Amount | 100 | 100 | 100 | 100 |
| | containing | mixed | | | | |
| | organopolysiloxane | (part(s) by | | | | |
| | | mass) | | | | |
| | (B) Mercaptoalkyl | Amount | 6.5 | 6.5 | 6.5 | 6.5 |
| | group-containing | mixed | | | | |
| | organopolysiloxane | (part(s) by | | | | |
| | | mass) | | | | |
| | (C) Photoinitiator | Amount | 1 | 1 | 1 | 1 |
| | | mixed | | | | |
| | | (part(s) by | | | | |
| | | mass) | | | | |
| | (D) Piperidone | Component | d3 | d3 | — | — |
| | derivative | Amount | 0.1 | 10 | 0 | 0 |
| | | mixed | | | | |
| | | (part(s) by | | | | |
| | | mass) | | | | |
| | (E) Hindered | Amount | 0 | 0 | 0 | 0 |
| | phenol | mixed | | | | |
| | compound | (part(s) by | | | | |
| | | mass) | | | | |
| | (F) Hindered | Component | — | — | f1 | f2 |
| | amine compound | Amount | 0 | 0 | 2 | 2 |
| | | mixed | | | | |
| | | (part(s) by | | | | |
| | | mass) | | | | |
| Evaluation | Curability at low | Rating | Excellent | Failure | Failure | Failure |
| | energy | | | | | |
| | Curing uniformity | Rating | Failure | Failure | Good | Good |
| | (presence or | | | | | |
| | absence of cured | | | | | |
| | coating) | | | | | |

### (Results of Evaluation)

The results of evaluation in Examples 1 to 17 described in Tables 1 to 4 show that the UV-curable polysiloxane composition of the present invention with a constitution including 0.5 to 5 parts by mass of the piperidone derivative (D) based on 100 parts by mass of the vinyl group-containing organopolysiloxane (A) was well cured to the inside even under UV irradiation conditions of low integrated light intensity, and no cured coating was formed on the surface of the cured product, and the surface and the inside were uniformly cured. This confirms that the composition has excellent curability at low energy and excellent curing uniformity.

Furthermore, the results of evaluation in the group of Examples 1 to 4 and Examples 13 to 15, in the group of Examples 5 to 8 and Example 16, and in the group of Examples 9 to 12 and Example 17 described in Tables 1 to 5 show that a UV-curable polysiloxane composition having excellent curability at low energy and excellent curing uniformity can be obtained by using any one of the 4-piperidone derivatives and the 2-piperidone derivatives as the piperidone derivative (D).

Moreover, the results of evaluation in Examples 1 to 12 described in Tables 1 to 3 and the results of evaluation in Examples 13 to 17 described in Table 4 show that the curability at low energy is further improved by using the piperidone derivative (D) and the hindered phenol compound (E) together. The results of Examples 13 to 15 show that the amount mixed of the hindered phenol compound, which provides the effect of improving the curability at low energy by using the piperidone derivative (D) and the hindered phenol compound (E) together, is preferably at least in the range of 0.5 to 5 parts by mass based on 100 parts by mass of the vinyl group-containing organopolysiloxane (A).

By contrast, the results of evaluation in Comparative Example 1 described in Table 5 and the results of evaluation in Comparative Examples 8, 9 described in Table 6 show that the UV-curable polysiloxane composition of Comparative Example 1 which did not include the piperidone derivative (D) had poor curing uniformity as a film-like surface layer in which curing has proceeded more than the interior was formed near the surface at the time of curing. Furthermore, although the UV-curable polysiloxane compositions of Comparative Examples 8 and 9 in which the hindered amine compound (F) was used instead of the piperidone derivative (D) had good curing uniformity, the compositions required high integrated light intensity of ultraviolet light for curing, and thus had poor curability at low energy.

The results of evaluation in Comparative Examples 2, 4, 6 described in Tables 5 and 6 show that the curing uniformity is poor when the proportion of the piperidone derivative (D) mixed is 0.1 part by mass based on 100 parts by mass of the vinyl group-containing organopolysiloxane (A). The results of evaluation in Comparative Examples 3, 5, 7 show that both the curability at low energy and the curing uniformity are poor when the proportion of the piperidone derivative (D) mixed is 10 parts by mass based on 100 parts by mass of the vinyl group-containing organopolysiloxane (A). This shows that it is important to set the proportion of the piperidone derivative (D) mixed to more than 0.1 part by mass and less than 10 parts by mass, and it is preferable to set the proportion range to 0.5 to 5 parts by mass.

### INDUSTRIAL APPLICABILITY

The UV-curable polysiloxane composition of the present invention is cured by ultraviolet light and has excellent uniformity of curing on the surface and in the inside even under conditions of UV irradiation at low integrated light intensity, and thus is useful as a damping material used for vibration control and damping in driving devices of small electric and electronic devices and precision machines.

1-9. (canceled)

10. A UV-curable polysiloxane composition comprising 100 parts by mass of an organopolysiloxane (A) having at least one vinyl group;
mercaptoalkyl group-containing organopolysiloxane (B) in such part(s) by mass that the number of moles of the mercaptoalkyl group is 0.1 to 1.0 mole based on 1 mole of the vinyl group of the organopolysiloxane (A);
0.1 to 5 parts by mass of a photoinitiator (C) based on 100 parts by mass of the organopolysiloxane (A); and
0.5 to 5 parts by mass of a piperidone derivative (D) based on 100 parts by mass of the organopolysiloxane (A).

11. The UV-curable polysiloxane composition according to claim 10, wherein the piperidone derivative (D) is a 4-piperidone derivative.

12. The UV-curable polysiloxane composition according to claim 11, wherein a functional group bonded to a nitrogen atom in a nitrogen-containing six-membered ring in the 4-piperidone derivative is a linear or branched alkyl group.

13. The UV-curable polysiloxane composition according to claim 11, wherein the 4-piperidone derivative is 1-methyl-4-piperidone.

14. The UV-curable polysiloxane composition according to claim 10, wherein the piperidone derivative (D) is a 2-piperidone derivative.

15. The UV-curable polysiloxane composition according to claim 14, wherein a functional group bonded to a nitrogen atom in a nitrogen-containing six-membered ring in the 2-piperidone derivative is a linear or branched alkyl group.

16. The UV-curable polysiloxane composition according to claim 14, wherein the 2-piperidone derivative is 1,5-dimethyl-2-piperidone.

17. The UV-curable polysiloxane composition according to claim 10, further comprising 0.5 to 5 parts by mass of a hindered phenol compound (E) based on 100 parts by mass of the organopolysiloxane (A).

18. The UV-curable polysiloxane composition according to claim 11, further comprising 0.5 to 5 parts by mass of a hindered phenol compound (E) based on 100 parts by mass of the organopolysiloxane (A).

19. The UV-curable polysiloxane composition according to claim 14, further comprising 0.5 to 5 parts by mass of a hindered phenol compound (E) based on 100 parts by mass of the organopolysiloxane (A).

20. A damping material comprising a cured product of the UV-curable polysiloxane composition according to claim 10.

21. A damping material comprising a cured product of the UV-curable polysiloxane composition according to claim 11.

22. A damping material comprising a cured product of the UV-curable polysiloxane composition according to claim 14.

23. A damping material comprising a cured product of the UV-curable polysiloxane composition according to claim 17.

24. A damping material comprising a cured product of the UV-curable polysiloxane composition according to claim 18.

25. A damping material comprising a cured product of the UV-curable polysiloxane composition according to claim 19.
